(19) United States
(12) Patent Application Publication
(10) Pub. No.: US 2007/0265852 A1
(43) Pub. Date: Nov. 15, 2007

(54) System and Method for the Distribution of Information

(75) Inventors: Robert Thompson, Kennebunk, ME (US); Arthur LeBlanc, Kennebunk, ME (US); Paul Suh, New York, NY (US); Carey M. Scott, New York, NY (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Flexplay Technologies, Inc., New Tork, NY (US)

(21) Appl. No.: 10/579,366

(22) PCT Filed: Aug. 6, 2004
(86) PCT No.: PCT/US04/25707

§ 371 Date: Jul. 11, 2007

(51) Int. Cl. G06Q 10/00; G06Q 30/00

(52) U.S. Cl. 705/1; 463/43

(57) ABSTRACT

The present disclosure relates to the field of digital information distribution. The last half-century has sen a manifold increase in the availability of information in a digital format. Such digital information, once created, can be copied any number of times without degradation of the original copy of the information. Furthermore, the information once digitized can, in theory, have an infinite lifetime. The present disclosure addresses the need to distribute digital information through various commercial transactions, wherein the lifetime of the distributed digital information is limited to a predetermined period of time. The present disclosure discloses systems and methods for the distribution of digital information on limited life optical media, wherein the limited life optical media includes a mechanism that physically and/or chemically limits the effective life of the digital information.

### FIELD OF INVENTION

The present invention relates to physical digital rights management, and in particular, to systems and methods for the distribution, promotion, sale, limiting the use of, and/or policing of information stored on media with a physical digital rights management mechanism(s).

### BACKGROUND

Information sits in a unique position when viewed as an item of commerce when compared with a physical good. Some characteristics of information include, for example, infinitely reproducible, virtually indestructible, subsequent users gain at not loss to the prior users, and easily disseminated. The nature of information makes it difficult for its creators to control once it is released. Moreover, the creators of information often make substantial investments to create the information. Due to the effective infinitely reproducible nature of information the potential exists that the creator of the information will not be able to recover his or her substantial investment. To this end a number of laws and regulatory regimes have been established, such as copyright laws, in an effort to provide adequate protection to the creators of information. However, it is impossible to perfectly police the misappropriation of information at all times and in all places.

In an effort to establish finer control over the distribution and sale of information a plethora of encryption and/or software based digital rights management (DRM) schemes have been developed. See, for example, products offered by Digimarc, ContentGuard, InterTrust, Reciprocal.com, Vyou.com, NetActive, Alchemedia, Aegisoft, Magex, and RightsMarket.

### SUMMARY

The present invention uses physical digital rights management to control the distribution of information. Physical digital rights management differs from encryption digital rights management in that the mechanism that limits the lifetime of information on any particular media is physically based as opposed to encryption based methods, which are software based methods. Physical digital rights management is based on some type of reactive agent and/or agents associated with the storage media. Once this agent and/or agents is activated the storage media undergoes a physical and/or chemical change in at least one property. The property change results in a change of the ability of the storage media reading device to read the storage media The present invention employs the advances in physical digital rights management to the distribution of information.

In one embodiment of the present invention, a method and system is disclosed for the distribution and/or policing of information, wherein the ease by which information is disseminated is curtailed.

In another overlapping embodiment of the present invention, a method and system is disclosed for the distribution, sale and/or promotion of video games.

In yet a further overlapping embodiment of the present invention, a method and system is disclosed that incentives the consumption of information.

In a further overlapping embodiment of the present invention, a method and system is disclosed for limiting the lifetime of time dependent information.

In another overlapping embodiment of the present invention, a method and system is disclosed for the basis of a new video game.

In another overlapping embodiment of the present invention, a method and system is disclosed for distributing software and/or software updates.

In yet a further overlapping embodiment of the present invention, a method and system is disclosed for the serialization of information.

In a further overlapping embodiment of the present invention, a method and system is disclosed that prevents and/or reduces the possibility of misappropriation of corporate and/or company trade secrets.

### DETAILED DESCRIPTION

Because most encryption based digital rights management systems are cracked, hacked and/or otherwise defeated shortly after their introduction into the marketplace there exists a need for a digital rights management system that is not defeatable.

Additionally, because not everyone has access to adequate data pipes (i.e., high speed access and/or data lines) and in some instances there are no data connection points available (i.e., outside a cell station; agents in the field; etc.) a further need exists for a digital rights management system that does not require a network or other centralized system and/or authorization system to activate the information and/or verify the legitimacy of the information and the user and the information to a particular user and/or physical or other connection point.

The embodiments of the present invention address these needs and more.

The embodiments of the present invention employ limited life information media, wherein the life of the information media is determined by a physical agent and/or physical mechanism. The physical agent and/or physical mechanism destroys and/or masks and/or makes inaccessible information stored on a physical media. For example, but not by way of limitation, an optical media, such as, for example, a compact disc and/or digital versatile disc is constructed such that it contains a reactive agent. The reactive agent allows the optical media to transform from a state that is initially readable to a state that precludes the information stored on the optical media unreadable or inaccessible. See, for example, U.S. Pat. Nos. 5,815,484; 6,434,109; 6,343,063; and 6,011,772 all of which are herein incorporated by reference in there entirety and U.S. patent application Ser. Nos. 10/163,473; 10/163,855; 10/163,472; 10/163,474; and 10/163,821 all of which are herein incorporated by reference in there entirety. Alternatively, there may be more than one reactive agent present in the optical media and there can exist more than two transition states, wherein the first state can be, for example, a state that makes the optical media unreadable initially.

In one embodiment of the present invention, information is stored on an optical disc. The optical disc contains a reactive agent such as, for example, a reactive dye whose initial state allows the information stored thereon to be read by an optical media reading device, but which transitions to a second state after a triggering event and/or stimulus to a state that is no longer readable by the optical media reading device.

Information encoded and/or stored on such limited life media allows a number of new methods and systems for doing business.

In an overlapping embodiment of the present invention, entertainment media such as, for example, movies can be stored on the limited life media to provide a method for video on demand without the use of a network. The limited life media can be distributed through any number of retail distribution channels. Moreover, the method does not incur any of the overhead costs associated with the rental businesses and/or cable video on the demand. No accounts have to be maintained. No physical connections have to be maintained. Further, the method provides for greater end user privacy. For example, if the content stored on the optical media were of an adult nature the end user might not wish to have a record exist that they viewed the content.

Additionally, because the optical media has a limited life and thus viewing window the ability of the end user to loan it to another user is greatly reduced. The limited life media narrows the number of end users that can watch the particular video thus the content provider can be reasonably assured of a single end user per optical media. The use of physical digital rights management precludes the possibility that the information can be hacked once the life of the optical media ends.

In a further overlapping embodiment of the present invention, time sensitive information is stored on a limited life media. For example, time varying information such as service manuals, parts catalogs, missile launch codes, a patient's medical information, medical procedures, etc., is stored on limited life media This ensures that older, out of date information is not being used when newer, more current and accurate information exists. For example, according to an overlapping embodiment of the present invention, certain companies updated their service manuals once a month. In this embodiment a limited life media, for example, an optical media, is constructed so that the life time of the media is one month. The limited life media would expire at the same time the updated manual arrived. Thus, despite the fact that multiple optical discs may be physically available the end user, only one disc will be live and that disc will contain the most current and/or recent version. Further, older information cannot be resold through auction sites such as eBay.com and the like because the media that information was stored on is no longer retrievable.

In yet a further overlapping embodiment of the present invention, a video game is distributed on limited life media. In this embodiment, one dimension of the game play is time. The end user must complete the game or certain tasks in the game before the life of the media expires. For example, the game scenario may be a spy theme wherein the end user has to complete a number of missions before the life of the media ends.

In another overlapping embodiment of the present invention, a video game is distributed on limited life media. In this embodiment, the video game includes a number of discrete levels and/or stages of play. Each level and/or stage of play is stored on separate limited life media For example, a video game that includes ten levels of play has each level stored on ten separate limited life media. The video game is thus serialized. Each level can be sold at a fraction of the cost of the whole game. For example, most newly released video games cost approximately $50 USD. This price point is often too high for the children that play such games. By serializing the game the cost of each level can be brought down to a more accessible level. Additionally, items and abilities collected in prior levels can be carried over to the most current level through the use of memory cards and/or stored on a hard disk drive and/or other memory device.

In a further overlapping embodiment of the present invention, a segment and/or single stage and/or level and/or sample of a video game is distributed on limited life media. For example, sequels to block buster video games are often highly anticipated. The game developer may wish to develop buzz about the sequel. In this embodiment of the present invention, a segment and/or single stage and/or level and/or sample of the sequel is distributed on limited life media. In one embodiment, the segment and/or single stage and/or level and/or sample of the sequel is distributed in limited supply. Further, accomplishing the goals of the segment and/or single stage and/or level and/or sample of the sequel before the media expires allows the end user special status. The special status may include the ability to purchase the sequel a predefined period of time before others and/or a special code stored on a memory device that unlocks and/or confers some unique functionality to this user for the sequel. Alternatively, achieving the goals of the segment and/or single stage and/or level and/or sample of the sequel may qualify the end user for special other promotional items and/or rewards. For example, other promotional items and/or rewards include receiving a newsletter reporting upcoming events, the opportunity to chat electronically with one of the characters from the video game and/or other merchandize, such as, discounts on action figures or other collateral associated with the video game and/or story line of the video game.

In another overlapping embodiment of the present invention, software and/or software updates are distributed on limited life media. Typically, end user purchase software and load it on their computer and then the media on which the software was sold just sits around and/or has to be stored. Because the media on which the software is sold is available long after the software is loaded on a particular system there exists a high probability that the software will be shared with other users, i.e., friends and family of the original purchaser. In an embodiment of the present invention, software and/or software updates are sold on a limited life media, for example, a limited play optical disc. The end user purchases the software on the limited life media. Once the end user activates for example, the reactive agent by opening the package the media is sold in, the end user has a predetermined amount of time in which to load the software on his or her computer, after which time the software on the limited life media becomes unreadable and thus unloadable. Thus, the software is less likely to be shared. If the end user would need a back up copy of the a software in case of a system crash and/or failure other identifying information sold with the software and/or registration information provided by the end user can be used to order an additional copy on a limited life media.

In a further overlapping embodiment of the present invention, newly released movies that do not have a wide theatre distribution are sold on limited life media into markets where the movie is not showing in a theatre. Typically, independent and/or art house and/or foreign films are not distributed in wide theatre release as are so called block buster movies from Hollywood. For example, New York City and Los Angeles are often times the only cities that certain movies have actual releases in theatres. Other markets have to wait until these movies are released on home video before they can see such films. In one embodiment of the present invention, movies that receive a limited theatre release are released at the same time as the theatre release on limited life media in markets where they would not typically have the opportunity to be shown in a theatre. This embodiment allows a larger distribution of the movie and coincides with the actual theatre release.

In another overlapping embodiment of the present invention, content is stored on a limited life media and is distributed freely for promotional purposes. For example, software companies may release samples of computer programs free of charge to potential customers. The customers have an opportunity to try it before they buy it, while the software company will feel secure in knowing that the sample release cannot be converted into the long playing, full version through a software hack.

Alternatively, content is stored on limited life media and once the life of the media expires the expired media can be brought back to the company or a partner of the company for discounts on future products and/or free admission to future releases and/or theme parks and/or free merchandise and/or other marketing collateral and/or newsletters and/or other preferential treatment and/or additional purchasing incentives.

In a further overlapping embodiment of the present invention, content is stored on a dual layer DVD, such as, for example, DVD-9. In this embodiment, the information on one layer is long playing, i.e., permanent, the information on the other layer has a limited life. For example, one layer, the long playing layer, may provide film discographies of the actors and/or director and/or others involved with a film; while the other layer, the limited life layer, contains the film. Additionally and/or alternatively, one layer, the long playing layer, contains extended trailers of the film or films coming to theatres in the near future and the other layer, the limited life layer, contains the film. Additionally and/or alternatively, one layer, the long playing layer, contains advertising and the other layer, the limited life layer, contains the film.

Accordingly, the present invention has been described at some degree of particularity directed to the exemplary embodiments of the present invention.

### Equivalents

As will be apparent to those skilled in the art to which the invention pertains, the present invention may be embodied in forms other than those specifically disclosed above without departing from the spirit or essential characteristics of the invention. The particular embodiments of the invention described above are, therefore, to be considered as illustrative and not restrictive.

What is claimed is:

1. A method for distributing video game content comprising:
providing a video game comprising discrete chapters; and
providing each discrete chapter on a limited play optical medium, wherein said each limited play optical medium comprises encoded information corresponding to a particular discrete chapter and a reactive material for limiting the length of time said encoded information is accessible.

2. The method according to claim 1, further comprising
providing an reward to the end user for each discrete chapter that is provided on a limited play optical medium, and for which the encoded information is no longer accessible, that is returned to a prescribed location.

3. The method according to claim 2, wherein said reward is a price discount on at least one of a future game or further game chapter.

4. The method according to claim 2, wherein said reward is a special code for unlocking hidden encoded information.

5. The method according to claim 2, wherein said reward is a special code for accessing a website.

6. The method according to claim 1, wherein at least one of the discrete chapters requires a user to finish the chapter before said encoded information becomes inaccessible in order to move on to the next chapter.
